(19) United States
(12) Patent Application Publication
(10) Pub. No.: US 2009/0066817 A1
(43) Pub. Date: Mar. 12, 2009

(54) IMAGE CAPTURE APPARATUS, IMAGE CAPTURE METHOD, AND STORAGE MEDIUM

(75) Inventor: Katsuya SAKAMAKI, Tachikawa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/208,431

(22) Filed: Sep. 11, 2008

(30) Foreign Application Priority Data
Sep. 12, 2007 (JP) 2007-236056

(51) Int. Cl. H04N 5/262

(52) U.S. Cl. 348/239; 348/E05.051

(57) ABSTRACT

An image capture apparatus comprises an image capture unit, a storage unit configured to store a pattern and an associated synthesizing-object image corresponding to a shape of the pattern, a display unit configured to display a capture image captured by the image capture unit and to superpose the pattern on the capture image, a first detector configured to detect a first control signal when the display unit displays the capture image, a reading unit configured to read from the storage unit the synthesizing-object image when the first detector detects the first signal, and a first display controller configured to control the display unit to superpose the synthesizing-object image on an area where the pattern is superposed.

### CROSS-REFERENCE TO RELATED APPLICATIONS

This application is based upon and claims the benefit of priority from prior Japanese Patent Application No. 2007-236056, filed Sep. 12, 2007, the entire contents of which are incorporated herein by reference.

### BACKGROUND OF THE INVENTION

1. Field of the Invention

The present invention relates to an image capture apparatus, an image capture method and a storage medium.

2. Description of the Related Art

Conventionally, an image capture apparatus which not only displays a captured image but also attaches various expressions to a recorded image has been designed. Therefore, the image capture apparatus reproduces and displays the recorded image with atmosphere.

For example, a technique which extracts an image area of a subject from a captured image and combines a character image similar to a shape (or pose) of the extracted image area with the captured image is provided.

### BRIEF SUMMARY OF THE INVENTION

It is an object of the present invention to allow a user to inspect immediately a desired synthesized image at a time of capturing an image.

According to an embodiment of the present invention, an image capture apparatus comprises, an image capture unit, a storage unit configured to store a pattern and an associated synthesizing-object image corresponding to a shape of the pattern, a display unit configured to display a capture image captured by the image capture unit and to superpose the pattern stored in the storage unit on the capture image, a first detector configured to detect a first control signal when the display unit displays the capture image, a reading unit configured to read from the storage unit the synthesizing-object image associated with the pattern superposed on the capture image displayed by the display unit when the first detector detects the first signal, and a first display controller configured to control the display unit to superpose the synthesizing-object image read by the reading unit on an area where the pattern is superposed.

According to another embodiment of the present invention, an image capture method for use with an image capture apparatus comprising an image capture unit, a display unit and a storage unit configured to store a pattern and an associated synthesizing-object image corresponding to a shape of the pattern, the method comprises displaying a capture image captured by the image capture unit and superposing the pattern stored in the storage unit on the capture image, detecting a first control signal when the display unit displays the capture image, reading from the storage unit the synthesizing-object image associated with the pattern superposed on the capture image displayed by the display unit when the first signal is detected, and controlling the display unit to superpose the read synthesizing-object image on an area where the pattern is superposed.

According to another embodiment of the present invention, a computer readable medium for computer program product for use with an image capture apparatus comprising an image capture unit, a display unit and a storage unit configured to store a pattern and an associated synthesizing-object image corresponding to a shape of the pattern, the computer program product comprises first computer readable program means for displaying a capture image captured by the image capture unit and superposing the pattern stored in the storage unit on the capture image, second computer readable program means for detecting a first control signal when the display unit displays the capture image, third computer readable program means for reading from the storage unit the synthesizing-object image associated with the pattern superposed on the capture image displayed by the display unit when the first signal is detected, and forth computer readable program means for controlling the display unit to superpose the read synthesizing-object image on an area where the pattern is superposed.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1A is a front view of an image capture apparatus according to an embodiment of the present invention;

FIG. 1B is a rear view of the image capture apparatus according to an embodiment of the present invention;

FIG. 2 is a block diagram showing a schematic configuration of the image capture apparatus;

FIG. 3 is a view showing a configuration of a program memory according to a first embodiment;

FIG. 4 is a view showing a configuration of a mask pattern table according to the first embodiment;

FIG. 5 is a flowchart showing a processing procedure of the first embodiment;

FIGS. 6A, 6B and 6C are views showing display transition according to the first embodiment;

FIG. 7 is a view showing a configuration of a condition setting table according to a second embodiment;

FIG. 8 is a view showing a configuration of a mask pattern table according to the second embodiment;

FIG. 9 is a flowchart showing a processing procedure of the second embodiment;

FIG. 10 is a flowchart showing a processing procedure of a third embodiment;

FIGS. 11A and 11B are views showing display examples according to the third embodiment; and

FIG. 12 is a block diagram showing a schematic configuration of the image capture apparatus according to a modification of the embodiments.

### DETAILED DESCRIPTION OF THE INVENTION

Embodiments of the present invention will now be described with reference to the accompanying drawings.

### First Embodiment

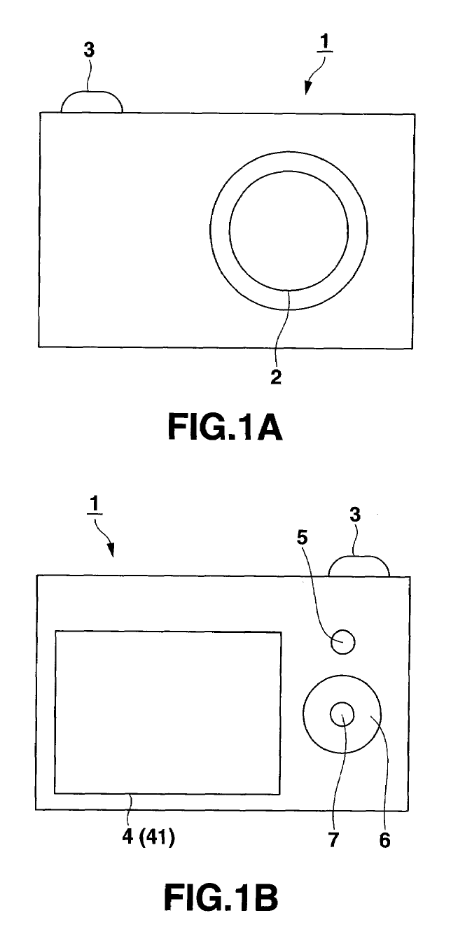

FIG. 1A is a front view showing an appearance of an image capture apparatus 1 according to the present embodiment and FIG. 1B is a rear view thereof.

An image capture lens 2 is provided on the front surface of the image capture apparatus 1 and a shutter key 3 is provided on the upper surface thereof.

The shutter key 3 has a so-called half shutter function, and can be depressed in two stages of half depression and full depression.

Further, a display device 4 including a liquid crystal display (LCD), a function key [A] 5 and a function key [B] 7 are provided on the back surface of the image capture apparatus 1.

A cursor key 6 having a ring shape is provided around the function key [B] 7. Up, down, right and left portions on the cursor key 6 can be depressed and indicate corresponding directions. A transparent touch panel 41 is laminated on the display device 4.

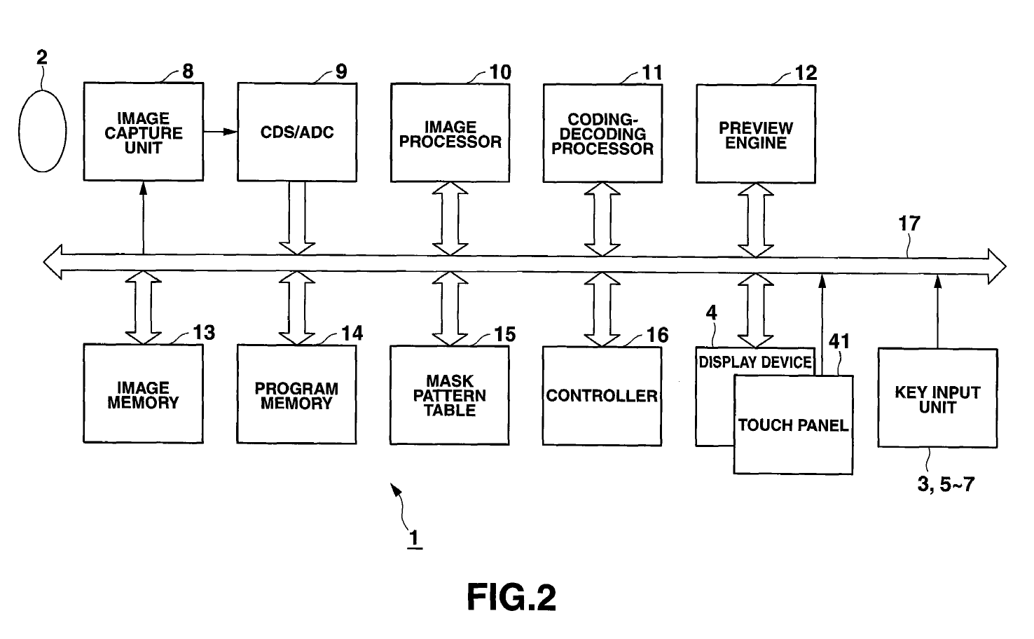

FIG. 2 is a block diagram showing a schematic configuration of the image capture apparatus 1.

The image capture apparatus 1 includes a controller 16 to which respective components of the image capture apparatus 1 are connected via a bus line 17. The controller 16 includes a one-chip microcomputer and controls the respective components.

An image capture unit 8 includes an image sensor such as a complementary metal-oxide semiconductor (CMOS) sensor and is arranged on an optical axis of the image capture lens 2 which includes a focus lens, and a zoom lens.

An analog image signal corresponding to an optical image of a subject output from the image capture unit 8 is input to the unit circuit 9. The unit circuit 9 includes a correlated double sampling (CDS) circuit which holds the input image signal, a gain control amplifier (automatic gain control (AGC) circuit) and an analog-to-digital converter (ADC). The gain control amplifier amplifies the image signal. The analog-to-digital converter converts the amplified image signal into a digital image signal.

An analog image signal output from the image capture unit 8 is converted into a digital image signal by the unit circuit 9 and transmitted to an image processor 10. The image processor 10 executes various image-processing on the digital image signal. Then, an image resulting from the image-processing is reduced in size by a preview engine 12 and displayed on the display device 4 as a live view image.

When storing an image, the image processed by the image processor 10 is coded and formed into a file format by a coding-decoding processor 11, and then stored in an image memory 13.

On the other hand, when reproducing an image, the image is read out from the image memory 13, decoded by the coding-decoding processor 11 and displayed on the display device 4.

When storing an image, the preview engine 12 executes controls which are required to display on the display device 4 the image that is immediately before being stored in the image memory 13, in addition to generation of a live view image.

The key input unit includes the shutter key 3, the function key [A] 5, the cursor key 6 and the function key [B] 7 shown in FIGS. 1A and 1B.

A program memory 14 and the mask pattern table 15 are connected to the bus line 17.

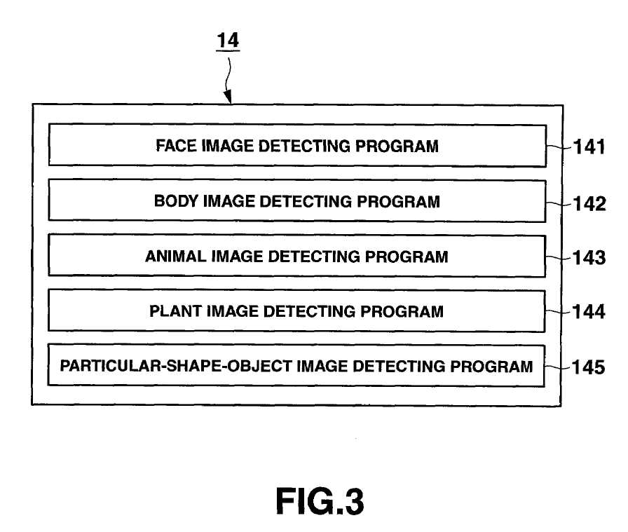

The program memory 14 stores a program to be used for executing processing shown in flowcharts which will be described later. Moreover, the program memory 14 stores a face image detecting program 141, a body image detecting program 142, an animal image detecting program 143, a plant image detecting program 144 and a particular-shape-object image detecting program 145, as shown in FIG. 3.

The face image detecting program 141 is a program used to detect a luminance-image-pattern area which can be regarded as a face image of a human being or an animal based on luminance signals of an image captured sequentially in a live view image display state.

The body image detecting program 142 is a program used to detect an image area which can be regarded as a body image of a human being based on difference (motion vector) between background pixels and other pixels and to detect a shape of an area of pixels having such difference in the image captured in the live view image display state.

The animal image detecting program 143 is a program used to detect an image area which can be regarded as an image of an animal based on difference (motion vector) between background pixels and other pixels and to detect a shape of an area of pixels having such difference in the image captured in the live view image display state.

The plant image detecting program 144 is a program used to detect an image area representing a whole plant, a portion of a flower or the like based on luminance component signals and chrominance component signals of the image captured in the live view image display state.

The particular-shape-object image detecting program 145 is a program used to detect a particular-shape-object image area, which is an image area having a particular shape, based on the luminance component signals and the chrominance component signals of the image captured in the live view image display state.

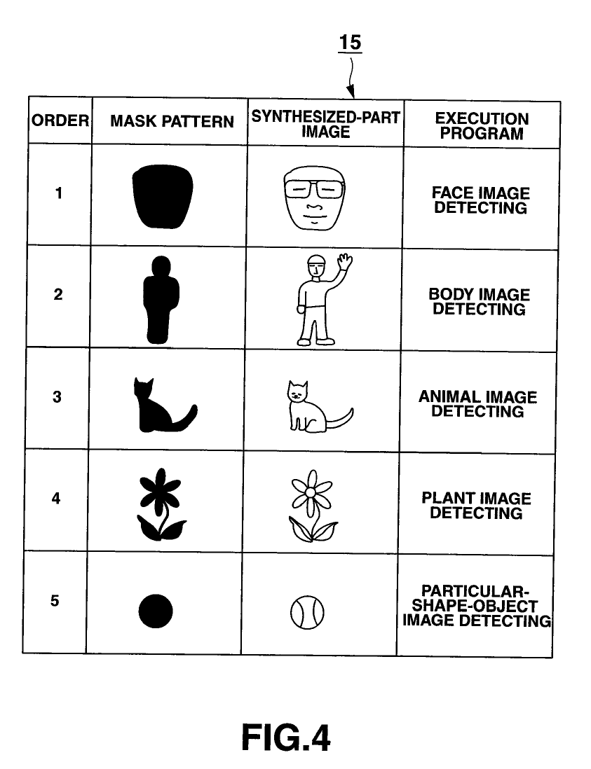

A mask pattern table 15 stores “mask pattern”, “synthesized-part image” and “execution program” in association with “order” (1 to 5), as shown in FIG. 4.

As the execution program, the image detecting programs 141 to 145 shown in FIG. 3 (face image detecting, body image detecting, animal image detecting, plant image detecting and particular-shape-object image detecting) are stored in association with numbers 1 to 5 of the “order”.

The mask pattern table 15 stores mask patterns in association with the respective execution programs. When any of the execution programs is executed and the controller 16 detects an image area of an associated detection target, a mask pattern associated with the execution program is displayed on the live view image.

The mask pattern table 15 also stores synthesized-part images, which are images to be synthesized with the live view image (synthesizing-objects), in association with the execution programs. When operation of the shutter key 3 is detected during execution of any of the execution programs, a synthesized-part image associated with the execution program currently being executed will be synthesized with an image to be stored.

Specifically, when a face image is detected from a live view image by executing the face image detecting program 141, a synthesized-part image (face image) and a mask pattern having a face shape associated with the face image detecting program are read out.

Shapes of a mask pattern and an associated synthesized-part image are not necessarily required to coincide with each other. Only a particular icon, symbol or numeral may form a mask pattern, provided the mask pattern can be distinguished from other mask patterns.

That is, in the present embodiment, the stored mask patterns are used to cover an image area of a synthesizing target in the live view image. However, it is not necessary to entirely cover the synthesizing target. Covering that allows the user to recognize “what kind of synthesized-part image is to be synthesized” in advance is sufficient.

In practice, the mask patterns and the synthesized-part images are stored in given areas in the image memory 13, and the mask pattern table 15 merely stores storage addresses of the mask patterns and the synthesized-part images in the image memory 13.

In the present embodiment, execution of the particular-shape-object image detecting program 145 detects an image area in the shape of a ball as the particular-shape-object image area as designated by the order 5 in FIG. 4.

Subsequently, operation of the image capture apparatus 1 according to the first embodiment will be explained.

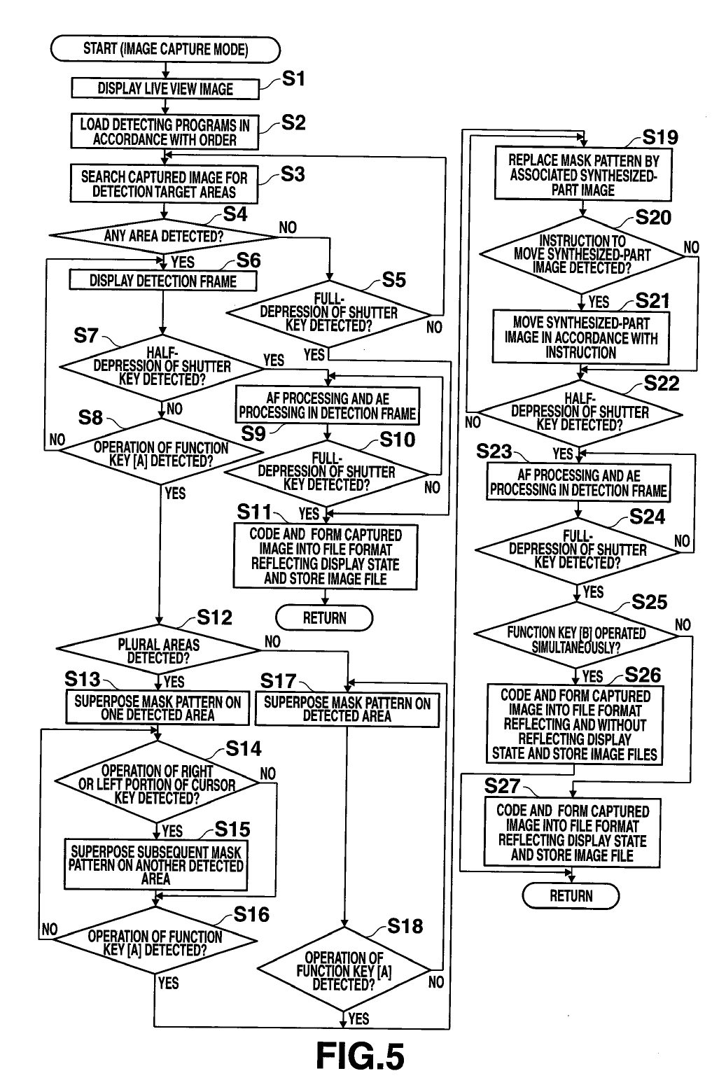

When an image capture mode is set, the controller 16 starts processing shown in the flowchart of FIG. 5 in accordance with a given program.

Firstly, a live view image which is sequentially captured by the image capture unit 8 is displayed on the display device 4 (step S1).

Then, in accordance with the order of the numbers from 1 to 5 stored in the mask pattern table 15, the associated detecting programs 141 to 145 are sequentially loaded (step S2).

An image captured by the image capture unit 8 is searched for detection target areas of the detecting programs 141 to 145 (step S3).

That is, an image output from the image capture unit 8 through the image processor 10 is searched for a face image area, a body image area, an animal image area, a plant image area and a particular-shape-object image area by use of the detecting programs 141 to 145.

Then, based on the search result, it is determined whether or not any of the face image area, the body image area, the animal image area, the plant image area and the particular-shape-object image area is detected (step S4).

When no target area is detected (NO in step S4), it is further determined whether or not full-depression of the shutter key 3 is detected (step S5). When the full-depression of the shutter key 3 is not detected (NO in step S5), the flow returns to step S3.

Therefore, the loop from step S3 to step S5 is repeatedly performed until any area is detected or the full-depression of the shutter key 3 is detected.

When any of a detection target is detected while the loop is repeated, the determination result of step S4 becomes YES.

Then, the flow proceeds from step S4 to step S6 and a detection frame is displayed around the detection target area detected in step S4 (step S6).

It is subsequently determined whether or not the half-depression of the shutter key 3 is detected (step S7).

When the half-depression of the shutter key 3 is not detected (NO in step S7), it is further determined whether or not operation of the function key [A] is detected (step S8). When the operation of the function key [A] is not detected (NO in step S8), the flow returns to step S6.

Therefore, after any detection target area is detected, the loop from step S6 to step S8 is repeatedly performed until the shutter key 3 is half-depressed or the function key [A] is operated.

When the function key [A] is operated while the loop is repeated, the determination result of step S8 becomes YES.

The flow proceeds from step S8 to step S12 and it is determined whether or not plural detection target areas are detected.

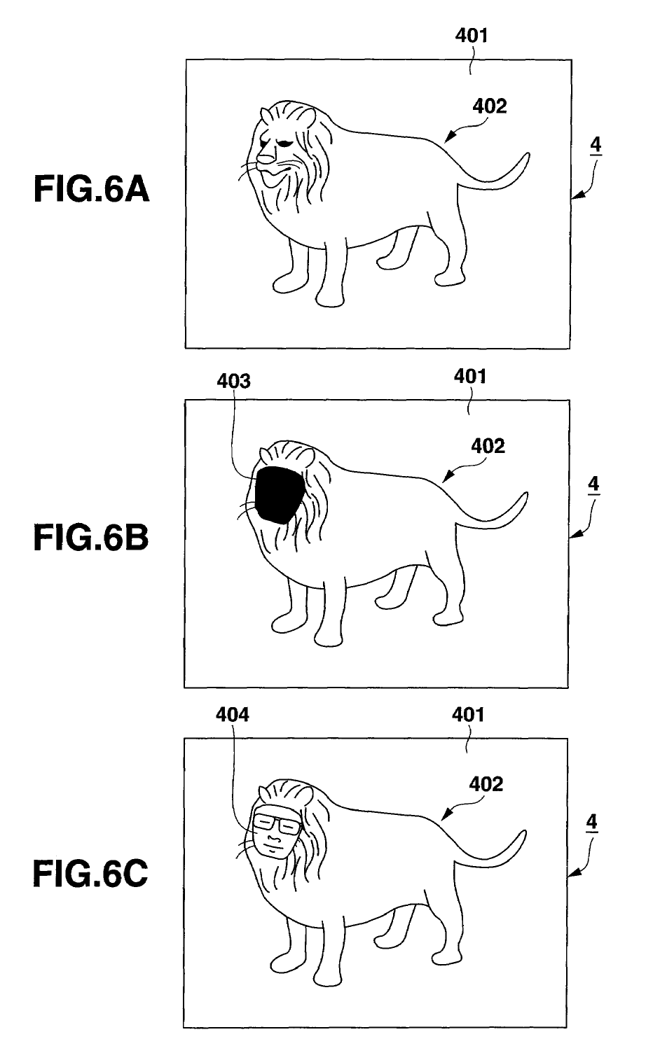

For example, as shown in FIG. 6A, an image of a lion (animal) 402 is displayed on the display device 4 as a live view image 401. Since the lion has a face and is an animal, a face image area that is the face of the lion is detected by the face image detecting program 141 and an animal image area that is the whole of the lion is detected by the animal image detecting program 143.

As plural target areas are detected in this example, the determination result is YES in step S12.

Then, the flow proceeds from step S12 to step S13. One of mask patterns corresponding to a detected target area is read from the mask pattern table 15 in accordance with the stored order, and the read mask pattern is superposed on the corresponding target area in the live view image (step S13).

The face image detecting program 141 is associated with the order 1 and the animal image detecting program 143 is associated with the order 3 in the mask pattern table 15, i.e., the order of the face image detecting program 141 is prioritized.

Therefore, in step S13, a mask pattern associated with the face image detection program 141 that is associated with the order 1 is read from the mask pattern table 15 and superposed on the detected face image area in the live view image.

As a result, as shown in FIG. 6B, a mask pattern 403 associated with the face image detecting program 141 is superposed on the face portion of the image of the lion 402 in the live view image 401.

Subsequently, it is determined whether or not operation of right or left portion of the cursor key 6 is detected (step S14). When the operation of right or left portion of the cursor key 6 is detected (YES in step S14), the subsequent mask pattern is read from the mask pattern memory 15 in response to the operation of the cursor key 6 and superposed on a corresponding detected target area.

In the example shown in FIGS. 6A, 6B and 6C, the face image area and the animal image area are detected as described above. A mask pattern that is associated with the animal image detecting program 143 and the order 3 is subsequent to the mask pattern 403 that is associated with the face image detecting program 141 and the order 1. That is, the mask pattern in an animal shape shown in FIG. 4 is regarded as the subsequent mask pattern. Therefore, the mask pattern having the animal shape is read from the mask pattern table 15 and superposed on the detected animal image area.

That is, operation of the cursor key 6 changes an area on which a mask pattern is superposed. In the example shown in FIGS. 6A, 6B and 6C, an area on which a mask pattern is superposed can be changed from the face image area (face portion of the lion) to the body image area (body portion of the lion) in response to operation of right or left portion of the cursor key 6.

Thus, operation of the cursor key 6 makes it also possible that the mask pattern of the animal image is superposed on the body portion of the image of the lion 402 with the face portion unchanged.

Thereafter, it is determined whether or not operation of the function key [A] is detected (step S16). When the operation is detected (YES in step S16), the flow goes to step S19.

When operation of the cursor key 6 is not detected in step S14 (NO in step S14), the flow goes to step S16 from step S14; and when operation of the function key [A] is detected in step S16 (YES in step S16), the flow proceeds from step S16 to step S19.

For example, when the user desires to accept the shape of the mask pattern 403 after viewing and recognizing the display state of FIG. 6B, the user operates the function key [A] without operating the cursor key 6. The controller 16 detects the operation of the function key [A] and maintains the display state of FIG. 6B. Then, the flow proceeds to step S19.

When it is determined in step S12 that plural areas are not detected (NO in step S12), namely, when one detection target area is detected by one detecting program, a mask pattern associated with the detecting program is read from the mask pattern table 15 and superposed on the detected area in the live view image (step S17).

When operation of the function key [A] is detected (YES in step S18), the flow proceeds to step S19.

In step S19, an associated synthesized-part image is superposed and displayed on the target area in place of the mask pattern.

As shown in FIG. 4, a face image associated with the order 1 in the mask pattern table 15 is to be superposed as a synthesized-part image, when the flow proceeds to step S19 in the state in which the above described display state shown in FIG. 6B is being displayed.

Thus, as shown in FIG. 6C, the synthesized-part image 404, i.e., the associated face image is superposed on the face image area of the image of the 402 in the live view image 401.

Therefore, the user can instantly inspect a desired synthesized image.

Next, it is determined, based on detection of operation of the touch panel 41, whether or not an instruction to move the synthesized-part image 404 is given (step S20).

When the instruction is detected (YES in step S20), the processing according to the detecting programs is interrupted. The synthesized-part image 404 is moved in accordance with the instruction and superposed on the live view image (step S21).

Therefore, when the user does not desire the position of the synthesized-part image 404 in the image of the lion 402 after viewing and recognizing the display state of FIG. 6C, the user touches a desired position in the image of the lion 402. The synthesized-part image 404 is moved to the touched position.

Thus, the position of the synthesized-part image 404 can be finely adjusted.

Subsequently, it is determined whether or not half-depression of the shutter key 3 is detected (step S22). When the half-depression of the shutter key 3 is detected (YES in step S22), auto-focus (AF) processing and automatic exposure (AE) processing are performed in the detection frame (not shown) displayed in step S6 (step S23).

Then, it is determined whether or not full-depression of the shutter key 3 is detected (step S24). When the full-depression of the shutter key 3 is detected (YES in step S24), it is further determined whether or not the function key [B] is simultaneously operated (step S25).

When the determination result of step S25 is YES, namely, when the user performs simultaneously the full depression of the shutter key 3 and the operation of the function key [B], a captured image is coded and formed into a file format and the file is stored in the image memory 13; moreover, the captured image is also coded and formed into a file format reflecting the display state of the live view image and the image file is stored in the image memory 13 (step S26).

Therefore, when the user performs full-depression of the shutter key 3 and operation of the function key [B] simultaneously, an image file including the image shown in FIG. 6A and an image file including the synthesized image shown in FIG. 6C are stored in the image memory 13 in association with each other.

When the determination result is NO in step S25, namely, when the user performs the full-depression of the shutter key 3 without operating the function key [B], the flow proceeds from step S25 to step S27. Then, a captured image is coded and formed into a file format reflecting the display state of the live view image and the image file is stored in the image memory 13 (step S27).

Therefore, when the user performs the full-depression of the shutter key 3 without operating the function key [B], only an image file including the synthesized image shown in FIG. 6C is stored in the image memory 13.

The user can give an instruction to store a synthesized image containing the synthesized-part image 404 and an image not containing the synthesized-part image 404. In addition, the user can give an instruction to store only the synthesized image containing the synthesized-part image 404. The instructions are made depending on whether or not the function key [B] is operated at the time when the shutter key 3 is fully depressed.

An image file based on a synthesized image is stored in association with a not-synthesized image file. Therefore, such reproduction manner that display changes from the not-synthesized image to the synthesized image (or vice versa) like an animation can be prepared in the reproduction mode.

On the other hand, while the loop from the step S3 to step S5 is repeatedly performed, when the full-depression of the shutter key 3 is detected (YES in step S5), the flow proceeds from step S5 to step S11.

When the half-depression of the shutter key 3 is detected while the loop from step S6 to step S8 is being repeatedly performed (YES in step S7), the flow proceeds from step S7 to step S9 and the AF processing and AE processing are performed in the detection frame (step S9).

Then, when the shutter key 3 is fully depressed (YES in step S10), the flow proceeds from step S10 to step S11.

In step S11 that is subsequent to step S5 or step S10, a captured image is coded and formed into a file format reflecting the display state of the live view image and the image file is stored in the image memory 13.

The processing of step S12 and thereafter is not performed while the loop from step S3 to step S5 or the loop from step S6 to step S8 is being repeated. Thus, only a live view image 401 is displayed on the display device 4 and a mask pattern 403 and a synthesized-part image 404 are not superposed on the live view image 401 during the processing of steps S9, S10 and S11.

Therefore, ordinary still image capture can be performed by operating only the shutter key 3 without operating the function key [A].

Moreover, not only a detection frame associated with single image detection program (e.g., face image detecting program) is displayed, but also plural detection frames are displayed around image areas detected by plural image detection programs. Accordingly, display of the detection frames is less affected by the subject image (subject to be captured and angle of view). As a result, delay in AF processing and AF processing can be prevented.

Other embodiments of the image capture apparatus according to the present invention will be described. The same portions as those of the first embodiment will be indicated in the same reference numerals and their detailed description will be omitted.

### Second Embodiment

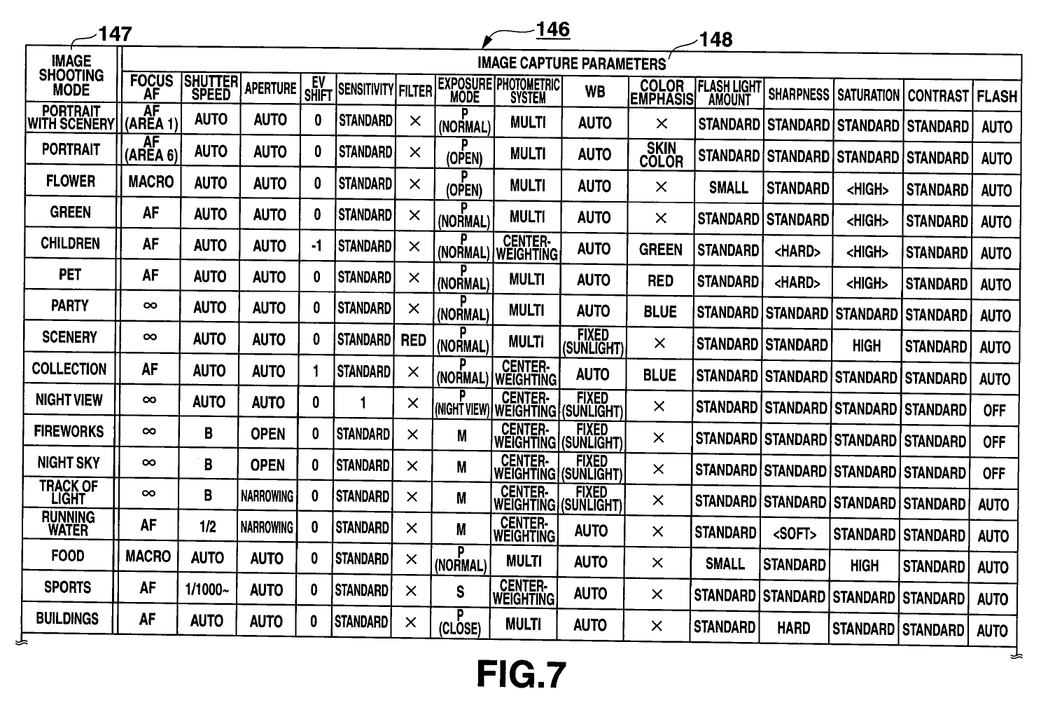

FIG. 7 is a view showing a configuration of a condition setting table 146 stored in the program memory 14 according to a second embodiment.

In the condition setting table 146, image capture parameters 148 are stored in association with image shooting modes 147. The image shooting modes 147 correspond to image capture scenes of “Portrait with scenery”, “Portrait” and the like.

Items of the image capture parameters 148 such as “focus”, “shutter speed”, “aperture” and the like are automatically set in the image capture apparatus 1 in accordance with an image shooting mode 147 selected by the user.

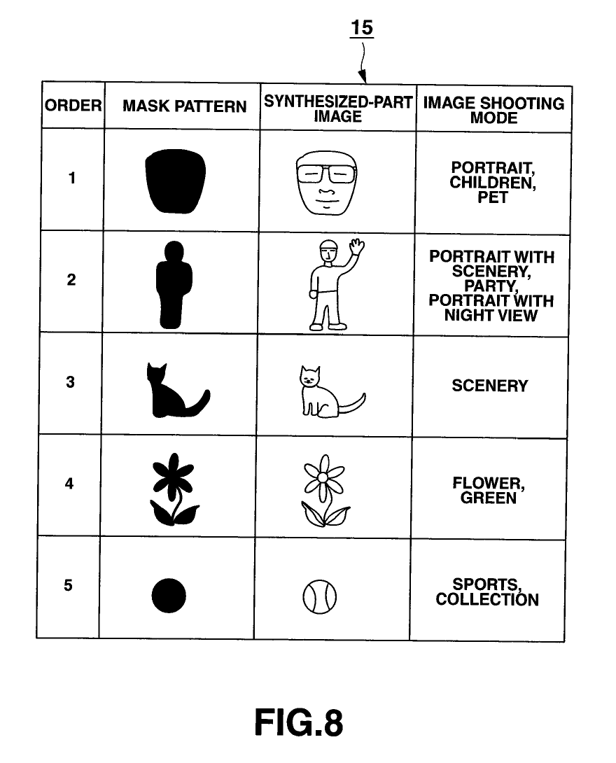

FIG. 8 is a view showing a configuration of a mask pattern table 15 according to the present embodiment. The mask pattern table 15 stores items including “mask pattern”, “synthesized-part image” and “image shooting mode” in association with “order” (1 to 5). The mask pattern memory table 15 stores names of image shooting modes 147 shown in FIG. 7, such as “portrait”, “children” and the like.

That is, when the user selects one of the image shooting modes 147 set in the condition setting table 146, a mask pattern and a synthesized-part image associated with the selected image shooting mode are read from the mask pattern memory 15 and the read mask pattern or the read synthesized-part image is superposed on the live view image.

For example, when one of “portrait”, “children” and “pet” is selected as the image shooting mode 147 from the condition setting table 146, a mask pattern and a synthesized-part image (face image) having a face shape associated with the selected mode are read from the mask pattern table 15.

Similarly to the first embodiment, shapes of a mask pattern and an associated synthesized-part image are not necessarily required to coincide with each other.

Furthermore, the mask patterns and the synthesized-part images are practically stored in given areas in the image memory 13, and the mask pattern table 15 merely stores storage addresses of the mask patterns and the synthesized-part images in the image memory 13.

In the present embodiment, unlike the first embodiment, plural image shooting modes are stored in association with a set of a mask pattern and a synthesized-part image.

Subsequently, operation of the image capture apparatus 1 according to the second embodiment will be explained.

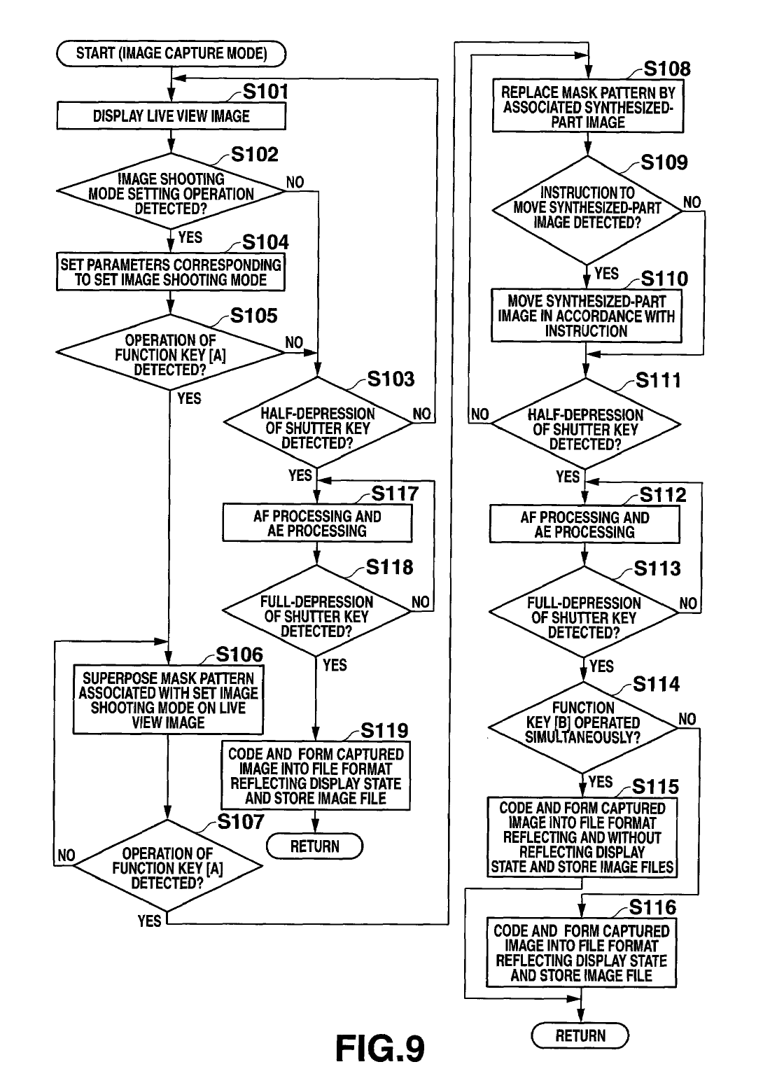

When an image capture mode is set, the controller 16 starts processing shown in the flowchart of FIG. 9 in accordance with a given program.

Firstly, a live view image is displayed on the display device 4 (step S101).

Then, it is determined whether or not operation to set one of the image shooting modes 147 stored in the condition setting table 146 is detected (step S102).

When the operation to set an image shooting mode is not detected (NO in step S102), it is determined whether or not half-depression of the shutter key 3 is detected (step S103). When the half-depression is not detected (NO in step S103), the flow returns to step S101.

The loop from step S101 to step S103 is repeatedly performed until one of the image shooting modes 147 is set or half-depression of the shutter key 3 is detected.

When the operation to set an image shooting mode is detected while the loop is repeated, the determination result of step S102 becomes YES.

Then, the flow proceeds from step S102 to step S104. Image capture parameters corresponding to the set image shooting mode are read from the condition setting table 146 and the read parameters are set (step S104).

Subsequently, it is determined whether or not operation of the function key [A] is detected (step S105). When the operation of the function key [A] is not detected (NO in step S105), the flow goes to step S103.

That is, the flow goes into the above-described loop that is from step S101 to step S103, and the loop is repeatedly performed until one of the image shooting modes 147 is set or half-depression of the shutter key 3 is detected.

On the other hand, when the operation of the function key [A] is detected in step S105 (YES in step S105), the flow proceeds from step S105 to step S106. A mask pattern associated with the set image shooting mode is read from the mask pattern memory 15 and superposed on the live view image (step S106).

For example, in the case where the image capture mode named “pet” which is associated with the order 1 is set, when the function key [A] is operated, a mask pattern associated with the order 1 is read from the mask pattern table 15 shown in FIG. 8 and superposed on the live view image.

Unlike the first embodiment described above, detection of image areas such as face image detection is not performed in the present embodiment. Accordingly, the read mask pattern is superposed on a preset area such as the center of the live view image or an arbitrary desired area.

Next, it is determined whether or not operation of the function key [A] is detected again (step S107). When the operation of the function key [A] is detected (YES in step S107), the flow proceeds to step S108. In step S108, the mask pattern is replaced by an associated synthesized-part image.

Therefore, the user can instantly inspect a desired synthesized image.

As described above, the mask pattern is superposed on a preset area in the live view image such as the center of the live view image or the arbitrary area in the present embodiment. That is, a position on which the synthesized-part image is superposed has no specific relation with the composition of the live view image.

Then, it is determined, based on detection of operation of the touch panel 41, whether or not an instruction to move the synthesized-part image is given (step S109).

When the instruction is detected (YES in step S109), the synthesized-part image is moved in accordance with the instruction and superposed on the live view image (step S110).

As a result, the synthesized-part image can be moved to an area where the user desires and superposed on the live view image. Thus, the synthesized-part image can be moved to an adequate position. For example, the synthesized-part image 404 can be adjusted to be superposed on the face portion of the image of the lion 402, as shown in FIG. 6C.

In the present embodiment, after the synthesized-part image is superposed and displayed on the live view image, the synthesized-part image is moved in response to operation of the touch panel 41. However, the mask pattern may be moved after the mask pattern is displayed in step S106; accordingly, the synthesized-part image is displayed at the position where the mask pattern has been moved to.

Subsequently, it is determined whether or not the half-depression of the shutter key 3 is detected (step S111). When the half-depression of the shutter key 3 is detected (YES in step S111), auto-focus (AF) processing and automatic exposure (AE) processing are performed (step S112).

Then, it is determined whether or not full-depression of the shutter key 3 is detected (step S113). When the full-depression of the shutter key 3 is detected (YES in step S113), it is further determined whether or not the function key [B] is simultaneously operated (step S114).

When the determination result of step S114 is YES, namely, when the user performs simultaneously the full-depression of the shutter key 3 and the operation of the function key [B], a captured image is coded and formed into a file format and the image file is stored in the image memory 13; moreover, the capture image is also coded and formed into a file format reflecting the display state of the live view image and the image file is stored in the image memory 13 (step S115). The image file reflecting the display state of the live view image is stored in association with the image file not reflecting the display state.

Therefore, when the user simultaneously performs full-depression of the shutter key 3 and operation of the function key [B], an image file including the image shown in FIG. 6A and an image file including the synthesized image shown in FIG. 6C are stored in the image memory 13.

When the determination result is NO in step S114, namely, when the user performs the full-depression of the shutter key 3 without operating the function key [B], the flow proceeds from step S114 to step S116.

The captured image is coded and formed into a file format reflecting the display state of the live view image and the image file is stored in the image memory 13 (step S116).

Therefore, when the user performs the full-depression of the shutter key 3 without operating the function key [B], an image file including the synthesized image shown in FIG. 6C is stored in the image memory 13.

The user can give an instruction to store a synthesized image containing the synthesized-part image 404 and an image not containing the synthesized-part image 404. Moreover, the user can give an instruction to store only the synthesized image containing the synthesized-part image 404. The instructions are made depending on whether or not the function key [B] is operated at the time when the shutter key 3 is fully depressed.

An image file based on a synthesized image is stored in association with a not-synthesized image file. Therefore, such reproduction manner that display changes from the not-synthesized image to the synthesized image (or vice versa) like an animation can be prepared in the reproduction mode.

Moreover, a synthesized-part image corresponding to a set image shooting mode is synthesized in the present embodiment. Accordingly, when reproducing or printing the image file including the synthesized image, resulting output can cause the user to easily recognize the image shooting mode in which the image is captured.

On the other hand, while the loop from step S101 to step S103 is repeatedly performed, when the half-depression of the shutter key 3 is detected (YES in step S103), the flow proceeds from step S103 to step S117. Then, the AF processing and the AE processing are performed (step S117). When the shutter key 3 is subsequently full depressed (YES in step S118), the flow proceeds from step S118 to step S119.

In step S119, a captured image is coded and formed into a file format reflecting the display state of the live view image and the image file is stored in the image memory 13.

The processing of step S105 and thereafter is not performed in the state in which the loop from step S101 to step S103 is repeated. Thus, only a live view image 401 is displayed on the display device 4 and a mask pattern and a synthesized-part image is not displayed on the live view image 401 during execution of the processing of steps S103, S117, S118 and S119.

Therefore, operating the shutter key 3 without operating the function key [A] can cause execution of ordinary still image capture with image capture parameters being set in accordance with an image shooting mode selected by the user.

### Third Embodiment

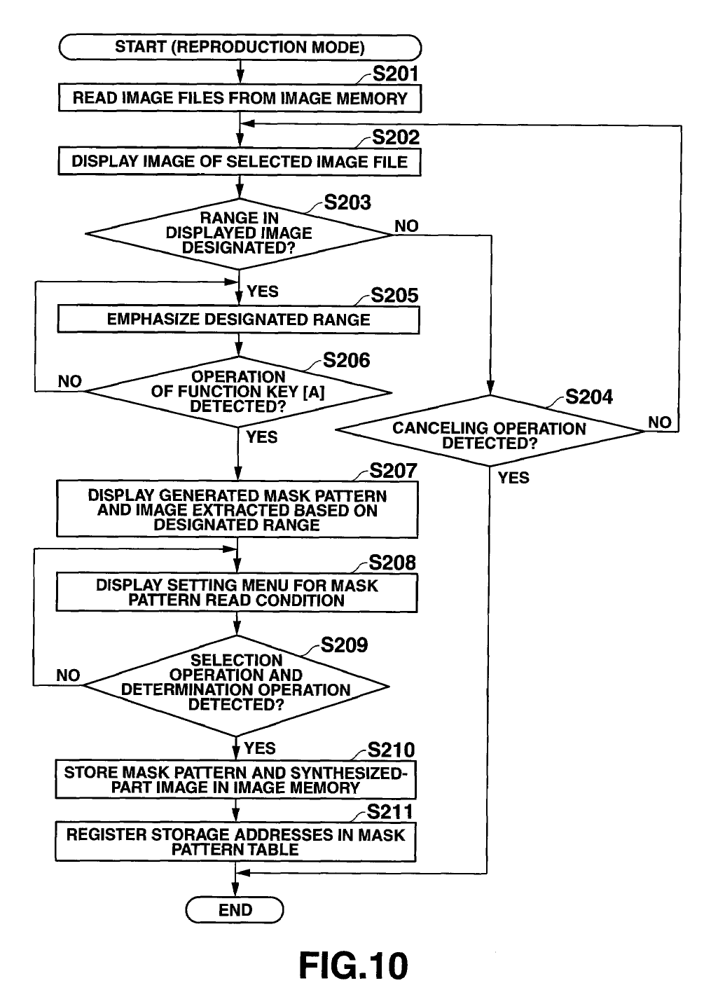

FIG. 10 is a flowchart showing a processing procedure in a reproduction mode according to a third embodiment of the present invention.

It is supposed that image capture processing of the present embodiment is also performed according to the flowchart shown in FIG. 5 (first embodiment) or the flowchart shown in FIG. 9 (second embodiment).

When the reproduction mode is set, the controller 16 starts processing shown in the flowchart of FIG. 10 in accordance with a given program.

That is, image files are read from the image memory 13 and file names of the read files are displayed on the display device 4 (step S201).

In response to operation made by a user for selecting a file name from the displayed file names, an image file corresponding to the selected file name is reproduced and an image contained in the image file is displayed on the display device 4 (step S202).

It is determined, based on whether or not operation of the touch panel 41 is detected, whether or not a certain range is designated in the image displayed on the display device 4 (step S203). When range designation is not detected (NO in step S203), it is determined whether or not canceling operation is detected (step S204). When the canceling operation is not detected (NO in step S204), the flow returns to step S203.

Therefore, the loop from step S202 to step S204 is repeatedly performed until a certain range is designated or the canceling operation is detected. While the above loop is repeatedly performed, when the canceling operation is detected (YES in step S204), this processing is terminated.

When the operation of the touch panel 41 is detected and a range is designated in the image displayed on the display device 4 (YES in step S203), the designated range is emphasized (step S205).

To emphasize the designated range, visibility of the designated range may be increased. Alternatively, visibility of the range other than the designated range may be decreased to emphasize the designated range.

Subsequently, it is determined whether or not operation of the function key [A] is detected (step S206).

When the operation of the function key [A] is detected (YES in step S206), a mask pattern corresponding to the designated range is generated, the image of the designated range is extracted as a synthesized-part image, and then, the generated mask pattern and the extracted synthesized-part image are displayed on the display device 4 (step S207).

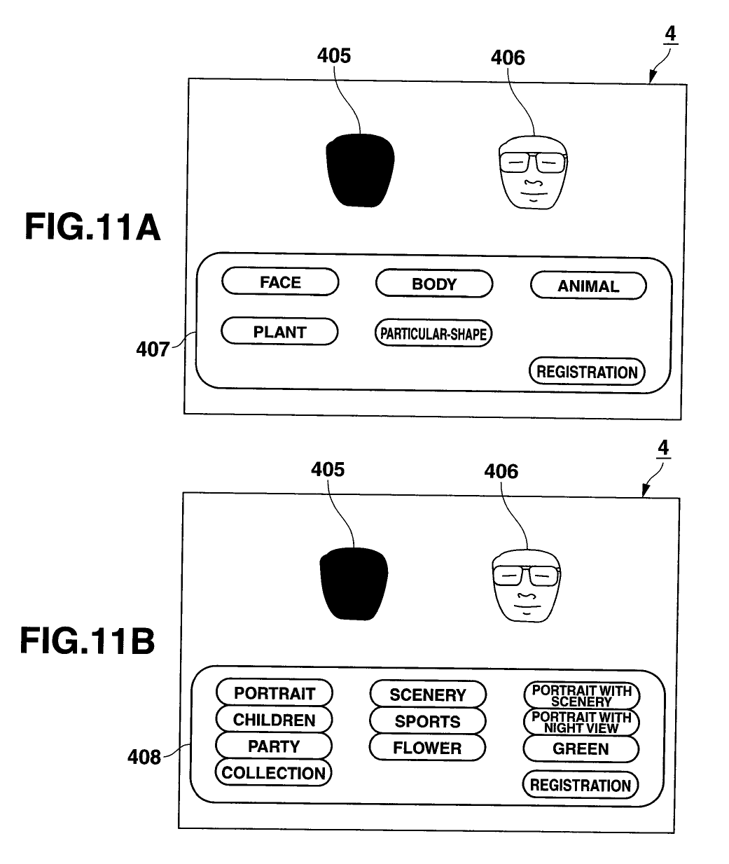

As a result of the processing of step S207, the mask pattern 405 and the synthesized-part image 406 are displayed on the display device 4, as indicated by a display example shown in FIG. 11A corresponding to the first embodiment, or as indicated by a display example shown in FIG. 11B corresponding to the second embodiment.

Next, a setting menu for setting a mask pattern read condition is displayed (step S208).

In the first embodiment, a mask pattern is read in response to detection of a face image area, a body image area, an animal image area, a plant image area or a particular-shape-object image area. That is, detection of an image area is regarded as a condition to read a mask pattern. Therefore, a setting menu 407 including area selection buttons and a “registration” button is displayed as shown in FIG. 11A. The area selection buttons include buttons indicating the above image areas such as “face”, “body” and the like.

On the other hand, in the second embodiment, a mask pattern is read in response to selection of one image shooting mode from image shooting modes 147, which respectively correspond to image shooting scenes such as “portrait with scenery”, “portrait” and the like. That is, selection of an image capture mode is regarded as a condition to read a mask pattern. Thus, a setting menu 408 including mode selection buttons and a “registration” button is displayed as shown in FIG. 11B. The mode selection buttons include buttons indicating the image shooting scenes such as “portrait with scenery”, “portrait” and the like.

Subsequently, it is determined whether or not selection operation and determination operation are detected (step S209).

According to the display example shown in FIG. 11A (first embodiment), when one of the area selection buttons is touched and the touch is detected, it is determined that the selection operation is detected. Detection of an image area corresponding to the detected selection operation is regarded as a selected mask pattern read condition. In addition, when the registration button is touched and the touch is detected, it is determined that the determination operation is detected and the selection of the mask pattern read condition is settled.

On the other hand, according to the display example shown in FIG. 11B (second embodiment), when one of the mode selection buttons is touched and the touch is detected, it is determined that the determination operation is detected. Selection of an image shooting mode corresponding to the detected selection operation is regarded as a selected mask pattern read condition. Moreover, when the registration button is touched and the touch is detected, it is determined that the determination operation is detected and the selection of the mask pattern read condition is settled.

In the case of the second embodiment, when the registration button is touched after a plurality of mode selection buttons are touched, a plurality of image shooting modes corresponding to the touched mode selection buttons can be selected in association with the set of the displayed mask pattern and synthesized-part image.

When the touch panel 41 detects touch on the setting menu 407 or 408 in accordance with the above procedure (YES in step S209), the displayed mask pattern and synthesized-part image are stored in the image memory 13 (step S210).

In addition, storage addresses of the mask pattern and the synthesized-part image in the image memory 13 are registered in the mask pattern table 15 in association with the mask pattern read condition selected in step S209 (step S211).

Specifically, the images of the mask pattern and the synthesized-part image are stored in given areas of the image memory 13, and storage addresses of the mask pattern and the synthesized-part image in the image memory 13 are stored in the mask pattern table 15.

According to the present embodiment, a mask pattern having a user-desired shape and a synthesized-part image having a user-desired image can be stored in the mask pattern table 15 in association with a mask pattern read condition.

For example, the synthesized-part image 404 in the image of lion 402 shown in FIG. 6C can be replaced by a face image of the user or a friend of the user. Therefore the image capture apparatus 1 can perform image reproduction that interests the user.

Modification

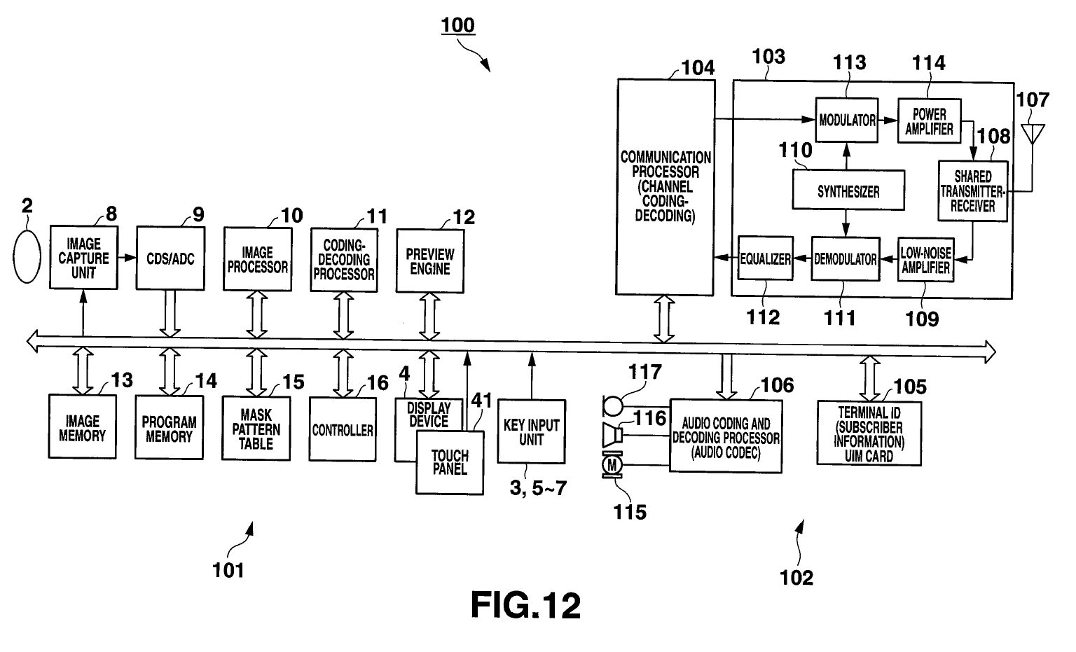

FIG. 12 is a block diagram showing a schematic configuration of the image capture apparatus according to modification of the embodiments. This modification represents an example in which the image capture apparatus is applied to a portable phone terminal 100.

The portable phone terminal 100 includes a camera section 101 and communication section 102. A configuration of the camera section 101 is similar to the image capture apparatus 1 shown in FIG. 2. The same portions are denoted by the same reference numerals and their detailed explanation will be omitted.

The communication section 102 includes a transmitter and receiver unit 103, a communication processor 104, a user identity module (UIM) card 105 and an audio coding and decoding processor 106.

For example, the transmitter and receiver unit 103 includes an antenna 107 that transmits and receives radio waves, on which a digital signal is superimposed, to and from a radio base station in conformity with a signal modulation-demodulation system determined by communication service provider, such as a code division multiple access (CDMA) system, a time division multiple access (TDMA) system.

A digital signal received by the antenna 107 is supplied via a shared transmitter-receiver 108 to a low-noise amplifier 109, and demodulated by a demodulator 111 that operates in response to a signal supplied from a synthesizer 110. Then, the digital signal is subjected to an equalization process by an equalizer 112 and supplied to the communication processor 104 that performs channel coding and decoding processing.

A digital signal coded by the communication processor 104 is modulated by a modulator 113 that operates in response to a signal supplied from the synthesizer 110. Then, the digital signal is amplified by a power amplifier 114 and radiated via the shared transmitter-receiver 108 from the antenna 107.

The program memory 14 includes an area for storing application software, an upper layer protocol and driver software. The controller 16 controls the communication section 102 based on the various programs stored in the program memory 14.

Driving the display device 4 under the control of the controller 16 enables display of characters contained in an e-mail or a variety of information and enables transmission of the displayed e-mail and images. Connecting to the World Wide Web (WWW) utilizing the communication service provider allows the user browsing a site on the Internet.

Accordingly, in the case where the image shown in FIG. 6C is displayed on the display device 4, when the displayed image is transmitted to the outside, the transmitted image can interest a viewer of the image who is on the outside.

The UIM card 105 stores subscriber-information including a terminal ID of the portable phone terminal 100.

The audio coding and decoding processor 106 functions as an audio CODEC (coder decoder), and a vibrator motor 115, speaker 116 and microphone 117 are connected to the audio coding and decoding processor 106.

The vibrator motor 115 rotates in synchronism with sound decoded by the audio coding and decoding processor 106 and generates vibration when the speaker 116 is in off-status.

The speaker 116 reproduces sound and received audio decoded by the audio coding and decoding processor 106. The microphone 117 detects audio input and supplies the audio input to the audio coding and decoding processor 106. The audio input is coded by the audio coding and decoding processor 106.

In addition to the image capture apparatus, the present invention can be applied to the portable phone terminal 100 having an image capture function. Moreover, the present invention can be easily applied to a camera-equipped personal computer and the like. That is, the present invention can be applied to any apparatus having an image capture function.

What is claimed is:

1. An image capture apparatus comprising:
an image capture unit;
a storage unit configured to store a pattern and an associated synthesizing-object image corresponding to a shape of the pattern;
a display unit configured to display a capture image captured by the image capture unit and to superpose the pattern stored in the storage unit on the capture image;
a first detector configured to detect a first control signal when the display unit displays the capture image;
a reading unit configured to read from the storage unit the synthesizing-object image associated with the pattern superposed on the capture image displayed by the display unit when the first detector detects the first signal; and
a first display controller configured to control the display unit to superpose the synthesizing-object image read by the reading unit on an area where the pattern is superposed.

2. The image capture apparatus according to claim 1, wherein
the storage unit further stores information related to a specific image area to be detected in association with the pattern, and
the image capture apparatus further comprises
a determination unit configured to determine whether or not the capture image includes the specific image area, and
a second display controller configured to read from the storage unit the pattern associated with the specific image area included in the capture image and to control the display unit so that the pattern read from the storage unit is superposed on the capture image.

3. The image capture apparatus according to claim 2, wherein the information related to the specific image area includes a processing program for the determination unit to determine whether or not the capture image includes the specific image area.

4. The image capture apparatus according to claim 1, wherein
the storage unit further stores an image shooting mode associated with the pattern, and
the image capture apparatus further comprises
a selection detector configured to detect selection of the image shooting mode, and
a third display controller configured to read from the storage unit the pattern associated with the image shooting mode corresponding to the selection and to control the display unit so that the pattern read from the storage unit is superposed on the capture image.

5. The image capture apparatus according to claim 1, further comprising
a second detector configured to detect a second control signal when the first display controller controls the display unit, and
a first recording unit configured to record the capture image and the synthesizing-object image superposed on the capture image when the second detector detects the second control signal.

6. The image capture apparatus according to claim 1, further comprising
a third detector configured to detect a third control signal when the first display controller controls the display unit, and
a second recording unit configured to record both the capture image on which the synthesizing-object image is superposed and the capture image on which the synthesizing-object image is not superposed when the third detector detects the third control signal.

7. The image capture apparatus according to claim 1, further comprising
an association unit configured to associate a synthesizing-object image with a condition to read the synthesizing-object image, and
a storage controller configured to control the storage unit to store the condition in association with the pattern which is associated with the synthesizing-object image.

8. The image capture apparatus according to claim 7, further comprising an extraction unit configured to extract a synthesizing-object image from the capture image.

9. The image capture apparatus according to claim 1, further comprising a transmitting unit configured to transmit outside an image displayed by the first display controller.

10. An image capture method for use with an image capture apparatus comprising an image capture unit, a display unit and a storage unit configured to store a pattern and an associated synthesizing-object image corresponding to a shape of the pattern, the method comprising:
displaying a capture image captured by the image capture unit and superposing the pattern stored in the storage unit on the capture image;
detecting a first control signal when the display unit displays the capture image;
reading from the storage unit the synthesizing-object image associated with the pattern superposed on the capture image displayed by the display unit when the first signal is detected; and
controlling the display unit to superpose the read synthesizing-object image on an area where the pattern is superposed.

11. A computer readable medium for computer program product for use with an image capture apparatus comprising an image capture unit, a display unit and a storage unit configured to store a pattern and an associated synthesizing-object image corresponding to a shape of the pattern, the computer program product comprising:
first computer readable program means for displaying a capture image captured by the image capture unit and superposing the pattern stored in the storage unit on the capture image;
second computer readable program means for detecting a first control signal when the display unit displays the capture image;
third computer readable program means for reading from the storage unit the synthesizing-object image associated with the pattern superposed on the capture image displayed by the display unit when the first signal is detected; and
forth computer readable program means for controlling the display unit to superpose the read synthesizing-object image on an area where the pattern is superposed.
